(19) United States
(12) Patent Application Publication
(10) Pub. No.: US 2004/0252451 A1
(43) Pub. Date: Dec. 16, 2004

(54) Internal peripheral connection interface

(75) Inventor: Jeremy I. Wilson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/458,455

(22) Filed: Jun. 10, 2003

(51) Int. Cl. G06F 1/16

(52) U.S. Cl. 361/685

(57) ABSTRACT

A computer system includes a chassis, a printed circuit board within the chassis, a plurality of peripherals within the chassis and a connection interface. The connection interface includes a first connector portion releasably connected to the first printed circuit board and a plurality of second connector portions. The plurality of second connector portions are connected to at least one of the plurality of peripherals within the chassis. The connector interface omits any active components.

### BACKGROUND

Known computer systems typically include one or more printed circuit assemblies to which are connected multiple cables from various sources such as peripherals including hard disk drives, removable disk drives (CD/DVD), displays, power sources and other printed circuit assemblies. Such cables are typically plugged into multiple individual connectors mounted on the printed circuit assembly of interest. When the printed circuit assembly (PCA) has to be removed from the system for repair or replacement, each individual cable must be disconnected from the printed circuit assembly. Reinsertion of the modified PCA or replacement PCA further requires that each individual cable be replugged or reconnected to the PCA. Insuring that the cables are connected to the proper location on the PCA is often difficult, increasing the frustration and time associated with repair or replacement of the PCA.

### BRIEF DESCRIPTION OF THE DRAWINGS

FIG. 1 is a schematic view of a computer system including an example of a connection interface of the present invention.

FIG. 2 is a perspective view of an alternative embodiment of the computer system of FIG. 1.

FIG. 3 is a perspective view of a printed circuit assembly, connection interface and cable of the computer system of FIG. 2.

FIG. 4 is an enlarged perspective view of the connection interface and cable of FIG. 3.

### DETAILED DESCRIPTION OF EXAMPLE EMBODIMENTS OF THE PRESENT INVENTION

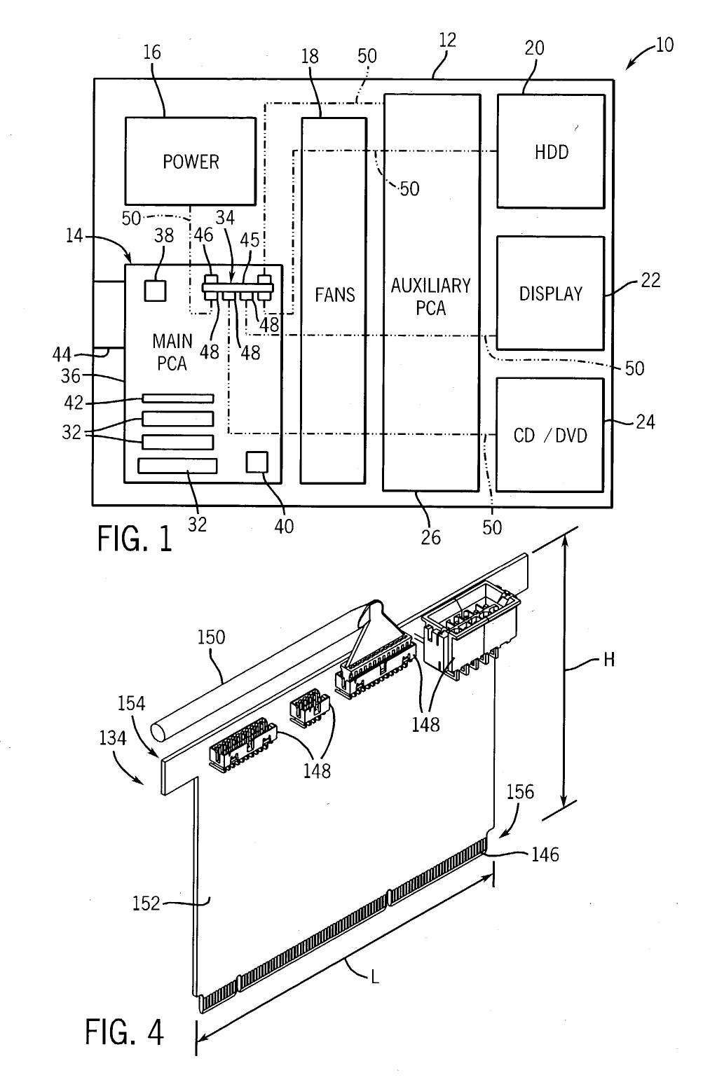

FIG. 1 schematically illustrates computer system 10 which generally includes chassis 12, main printed circuit assembly 14, peripherals 16, 18, 20, 22, 24, 26, daughter cards 32 and connection interface 34. Chassis 12 generally constitutes one or more structures configured to serve as a framework, housing or support for the remainder of computer system 10. The exact configuration of chassis 12 may vary depending upon the particular function of computer system 10, the size requirements imposed upon by the rack or vertical support structure which supports computer system 10, and the number, size and relative location of devices within chassis 12.

Main printed circuit board assembly 14 is positioned within chassis 12 and generally includes printed circuit board 36, at least one active component, such as at least one processor 38, and a controller 40. As known to those of ordinary skill in the art, “active components” are those components generally configured to perform at least some steps of logic (sometimes utilizing transistors and the like) in creating, storing, manipulating or transmitting data signals. In contrast, “passive components” are components that do not utilize logic such as capacitors, resistors and the like. In the embodiment illustrated, printed circuit assembly 14 additional includes at least one board or card connector 42 and a set of external input/output connectors 44. In the embodiment illustrated, printed circuit assembly 14 does not include any cable connectors.

Printed circuit board generally comprises a conventionally known or future developed printed circuit board configured to support the remaining structures of printed circuit assembly 14. Processor 38 is coupled to printed circuit board 36 and generally comprises an integrated circuit. Controller 40 generally routes or directs data signals to, from and along printed circuit board 36. In the embodiment illustrated, controller 40 includes a data bus controller configured to direct data signals to and from peripherals 16, 18, 20, 22, 24 and 26.

Connectors 42 generally comprise connectors configured to connect cards or boards to printed circuit board 36. Examples of such cards or boards for which connector 42 may be configured to work with include input/output cards, memory cards such as DIMMS and various other conventionally known or future developed daughter cards. Connectors 42 may comprise any one of a variety of conventionally known or future developed connector mechanisms such as keyed or unkeyed PCI connectors, pin connectors and the like.

External input/output connectors 44 generally comprise conventionally known or future developed connectors directly coupled to circuit board 36 and exposed to an exterior of chassis 12. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Connectors 44 facilitate connection of external devices to computer system 12. In alternative embodiments, input/output connectors 44 may be provided as part of input/output boards connected to printed circuit board 36 via connectors 42.

Peripherals 16, 18, 20, 22 and 24 generally comprise devices which are supported within chassis 12 and which are distinct from circuit board assembly 14 but which are in communication with printed circuit board assembly 14. FIG. 1 illustrates but a few examples of such peripherals. Peripheral 16 comprises a power source. Peripheral 18 comprises fans or other cooling mechanisms. Peripheral 20 comprises a hard disk drive. Peripheral 22 comprises a display possibly including external controls for computer system 10. Peripheral 24 is illustrated as a removable or portable disk drive such as a CD or DV drive. Peripheral 26 is illustrated as a second or auxiliary printed circuit assembly. Auxiliary printed circuit assembly includes one or more active components and may include one or more board connectors (not shown). In alternative embodiments, computer system 10 may include fewer than all of the peripherals illustrated or alternative or additional peripherals. For example, in one embodiment, computer system 10 includes only a single printed circuit assembly which supports all of the processors and controllers of computer system 10.

Connection interface 34 generally comprises a mechanism which interfaces between two or more of peripherals 16, 18, 20, 22, 24 or 26 and, printed circuit board 36 of printed circuit assembly 14. Connection interface 34 is releasably connected to printed circuit board 36 while also being connected to peripherals 16, 18, 20, 22, 24 and 26. Connection interface 34 generally includes a body 45 supporting a board connection portion 46 and a plurality of peripheral connection portions 48. Body 45 supports data signal transmission lines, such as electrically conductive traces, internal wires, or optical signal transmission lines, extending between portion 48 and portion 46. Although body 45 is illustrated as a card, body 45 may have a variety of different shapes and configurations such as a cylindrical hub.

Board connection portion 46 generally comprises a portion of interface 34 configured to facilitate releasable connection of interface 34 to printed circuit board 36. Portion 46 is schematically illustrated with respect to both its configuration and location. Portion 46 may extend along a lower surface of interface 34 or along lower sides of interface 34. In one embodiment, portion 46 comprises an edge connector. In another embodiment, portion 46 includes either pins or female receptacles to facilitate such connections.

Peripheral connection portions 48 generally comprise conventionally known or future developed connectors that are connected to one or more of peripherals 16, 18, 20, 22, 24, 26 to facilitate communication of data signals between such peripherals and connector portion 46 which ultimately results in transmission of such data signals to or from printed circuit assembly 14. In the embodiment illustrated, such communication is provided by a plurality of cables 50 extending between peripherals 16, 18, 20, 22, 24, 26 and portions 48. Cables 50 have one end that is releasably connected to either one of peripherals 16, 18, 20, 22, 24 or 26 or one of connector portions 48. In one embodiment, one end of cable 50 is releasably connected to a peripheral, while the other end of cable 50 is releasably connected to one of connector portions 48.

Overall, connection interface 34 facilitates simultaneous connection and disconnection of a plurality of peripherals to and from printed circuit board 36. As a result, to replace or repair or otherwise modify printed circuit assembly 14, an individual can simply disconnect interface 34 rather than having to individually disconnect each individual peripheral (or its cable) from printed circuit board 36 or having to remember where to specifically connect each peripheral (or its cable) to circuit board 36. Consequently, repair or replacement of printed circuit assembly 14 is easier and requires less time.

In addition, interface 34 connects peripherals (or their cables) to printed circuit board 36 so that data signals are transmitted from one of peripherals 16, 18, 20, 22, 24, 26 and circuit board 36 to the other of peripherals 16, 18, 20, 22, 24 and 26 and circuit board 36 across interface 34 without being received by an active component. Because interface 34 does not include any active component in the embodiment shown, interface 34 has an inherent minimal chance of failure. As a result, the frequency of interface 34 needing repair or replacement, which would require disconnection of each of the peripherals from interface 34 and reconnection to the same connector portions 48, is minimized.

Moreover, because interface 34 connects a plurality of peripherals to printed circuit board 36 at a single condensed or impact area on printed circuit 36 using a single connector portion, interface 34 reserves valuable space on printed circuit board 36 for the coupling or mounting of other components or connectors to printed circuit board 36. In sum, interface 34 provides a low cost, robust and space-saving means for simultaneously connecting and disconnecting a plurality of peripherals to printed circuit board 36.

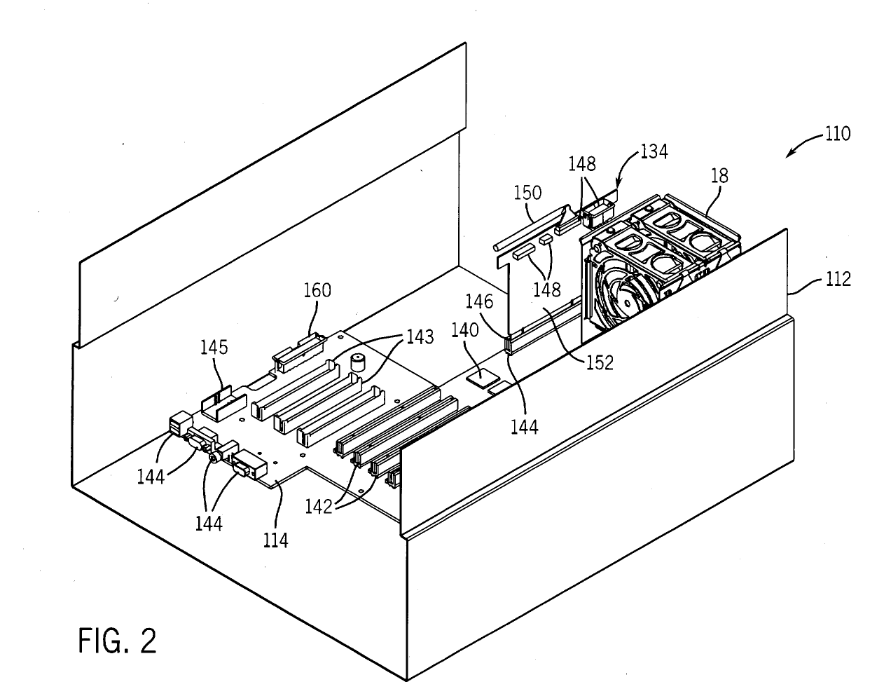

FIGS. 2-4 illustrate portions of a computer system 110, an alternative embodiment of system 10. System 110 generally includes chassis 112, printed circuit board assembly 114, peripherals 15, 20, 22, 24 and 26 (shown in FIG. 1), cards 32 (shown in FIG. 1) and connection interface 134. As shown in FIG. 2, chassis 112 is generally a housing framework or other enclosure structure which supports and receives the remaining internal devices of computer system 110. For ease of illustration, a substantial portion of chassis 112 is omitted.

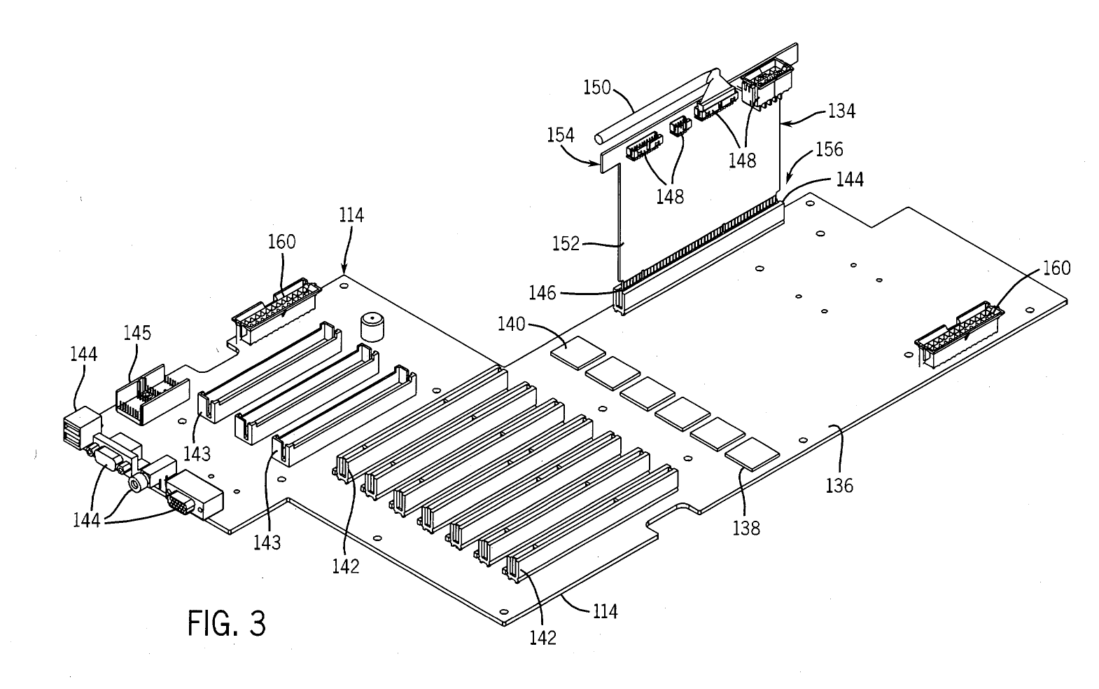

Printed circuit board assembly 114 (best shown in FIG. 3) includes printed circuit board 136, a plurality of active components including at least one processor 138, a controller 140, and card connectors 142, 143 and 144. Printed circuit assembly 114 further includes a diagnostic board connector 145 facilitating connection of a diagnostic device to printed circuit assembly 114. Processor 138 and controller 140 are substantially identical to processor 38 and controller 40 shown and described with respect to FIG. 1. Processor 138 comprises an integrated circuit chip affixed to printed circuit board 136 and configured to process or manipulate data signals using predefined logic (typically employing a multitude of transistors). Controller 140 comprises an integrated circuit chip affixed to circuit board 136 and configured to route or direct data signals along printed circuit board 136 as well as to and from components or devices connected to printed circuit board 136. In alternative embodiments, one or more of processor 138, controller 140 or card connectors 142, 143 and 44 may be omitted from assembly 114.

Card connectors 142, 143 and 144 generally comprise connectors for connecting cards or boards to printed circuit board 136. Card connectors 142 comprise conventionally known PCI connectors. In the embodiment illustrated, connectors 142 are configured to receive memory cards or DIMMS. Card connector 143 comprises voltage regulation module connectors. Card connector 144, like card connector 142, generally comprises a keyed PCI connector. Card connector 144 is configured to connect connection interface 134 to printed circuit board 136.

Connection interface 134 simultaneously connects four peripherals such as power source 16, hard disk drive 20, display 22 and removable disk drive 24 to printed circuit board 136. In the embodiment illustrated, connection interface 134 comprises an extender board which includes a printed circuit board 152, a board connector portion 146 and peripheral connector portions 148. Board connector portion 146 generally comprises a connector affixed to printed circuit board 152 and configured to connect printed circuit board 152 to printed circuit board 136. In the embodiment illustrated, connector portion 146 comprises an edge connector configured to be received within the keyed opening of board connector 144. In alternative embodiments, connector portion 146 may have other configurations depending upon the configuration of board connector 144.

Peripheral connector portions 148 generally comprise cable connectors configured to releasably connect the respective cable extending from a respective peripheral. For ease of illustration, FIG. 3 illustrates only a single cable 150 releasably connected to one of connector portions 148.

As further shown by FIG. 3, peripheral connector portions 148 generally extend along an edge portion 154 opposite to edge portion 156 along a portion of which connector portion 146 extends. Connector portions 148 generally face away from printed circuit board 136 in a vertical direction. Although connector portions are illustrated as comprising different configured connectors, connector portions 148 may alternatively comprise similarly configured connectors. Furthermore, although printed circuit assembly 114 is illustrated as including peripheral connectors such as power connectors 160 connected or coupled to printed circuit board 136, such power connectors 160 may alternatively be coupled to printed circuit board 152.

When system 110 is fully assembled and operating, data signals are transmitted from the peripherals, through cables extending between the peripherals and connector portions 148, through printed circuit board 152 and to printed circuit board 136 via connector portions 146 and 144. The transmission of data signals through printed circuit board 152 or, more particularly in selected electrically conductive traces of board 152, occurs without the data signals being manipulated, stored or otherwise processed by an active component. In the particular embodiment illustrated, printed circuit board 152 does not include any active components. As noted above, this renders interface 134 less susceptible to failure which would require disconnection of each of the cables 150 connected to connector portions 148.

In addition to achieving the aforementioned benefits as discussed above with respect to connection interface 34, connection interface 134 provides even greater cost savings and convenience. In particular, because connection interface 134 utilizes a printed circuit board 152 for providing data transmission lines between connection portions 146 and 148, connection interface 134 may be manufactured utilizing conventionally known printed circuit board technology. Moreover, connector portion 146 as well as connector 144 on printed circuit board 136 may be provided by conventional or standard board or card connection components. Because connector portions 148 generally extend along edge portion 154 opposite printed circuit board 136, connector portions 148 are elevated with respect to printed circuit board 136 and other components or devices connected to printed circuit board 136, providing improved access to connector portions 148. Moreover, because connector portions 148 generally face in a vertical direction or away from printed circuit board 136, easier connection of cables 150 to connector portions 148 is facilitated. In addition, because printed circuit board 152 of connection interface 134 has a small footprint on the surface of printed circuit board 136, connection interface 134 conserves precious space on printed circuit board 136.

Printed circuit board 152 is dimensioned so as to be self-supporting without additional fasteners when connected to printed circuit board 136 by connector 144. In the particular embodiment illustrated, printed circuit board 152 has a length L less than a length of printed circuit board 136 and preferably no greater than 5.0 inches. To facilitate connection of cables 150 to connector portions 148 within chassis 112, printed circuit board 152 has a height H of no greater than 5.0 inches. In alternative embodiments, chassis 112 or the position of printed circuit board 136 may be modified to accommodate connection interfaces 134 having longer or taller printed circuit boards 152. Although less desirable, additional fasteners may be employed to assist in supporting interfaces 134 such as when interface 134 includes a larger printed circuit board 152.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A computer system comprising:
a chassis;
a first printed circuit board within the chassis;
a plurality of peripherals within the chassis;
a plurality of cables connected to the plurality of peripherals; and
a second printed circuit board releasably connected to and supported by the first printed circuit board and releasably connected to the plurality of cables, wherein the second printed circuit board does not support any active components.

2. The system of claim 1 including a plurality of cable connectors coupled to the second printed circuit board and releasably connecting the plurality of cables to the second printed circuit board.

3. The system of claim 2, wherein the plurality of cable connectors face in a direction perpendicular to the first printed circuit board.

4. The system of claim 2, wherein the second printed circuit board has a first edge proximate the first printed circuit board and a second opposite edge and wherein the plurality of cable connectors are proximate the second edge.

5. The system of claim 2, wherein the plurality of cable connectors include at least three connectors.

6. The system of claim 1 including at least one active component coupled to the first printed circuit board.

7. The system of claim 1 including at least one input/output card coupled to the first printed circuit board.

8. The system of claim 1 including active components and input/output cards, wherein all of the active components and all of the input/output cards of the system are connected to and supported by the first printed circuit board.

9. The system of claim 1, wherein one of the plurality of peripherals includes an auxiliary printed circuit assembly.

10. The system of claim 1, wherein the plurality of peripherals includes peripherals selected from a group including:
a display;
a hard disk drive;
a removable disk drive; and
a power source.

11. The system of claim 1 including a plurality of connectors coupled to the first printed circuit board and configured to connect the first printed circuit board to devices external to the chassis.

12. The system of claim 1, wherein the second printed circuit board does not support passive components.

13. The system of claim 1 including:
a PCI connector coupled to the first printed circuit board; and
an edge connector coupled to the second printed circuit board, wherein the edge connector is releasably received within the PCI connector.

14. The system of claim 1, wherein all peripherals within the chassis are connected to the second printed circuit board by cabling.

15. The system of claim 1, wherein the first printed circuit board does not include any internal cable connectors.

16. The system of claim 1, wherein the first printed circuit board has a first length and wherein the second printed circuit board has a second length parallel to the first length and shorter than the first length.

17. The system of claim 1, wherein the second printed circuit board has a maximum length of about 5.0 inches.

18. A computer system comprising:
a chassis;
a printed circuit board within the chassis;
a plurality of peripherals within the chassis; and
a connection interface including:
a first connector portion releasably connected to the first printed circuit board; and
a plurality of second connector portions, each second connector portion being connected to at least one of the plurality of peripherals within the chassis, wherein the connector interface omits any active components.

19. The system of claim 18 including a plurality of cables between the plurality of peripherals and the plurality of second connector portions.

20. The system of claim 19, wherein an end portion of each of the plurality of cables is releasably connected to either one of the plurality of peripherals or one of the plurality of second connector portions.

21. The system of claim 15 including a cable extending between one of the plurality of peripherals and one of the plurality of second connector portions, wherein the cable has an end portion releasably connected to either said one of the plurality of peripherals or said one of the plurality of second connector portions.

22. The system of claim 18, wherein the connection interface includes a printed circuit board between the first connector portion and the plurality of second connector portions.

23. The system of claim 18, wherein the first connector portion and the plurality of second connector portions face in opposite directions.

24. A connection interface for use in a computer system having a chassis, a first printed circuit board within the chassis, and a plurality of peripherals within the chassis, the interface comprising:
a first connector portion configured to be releasably connected to the first printed circuit board; and
a plurality of second connector portions configured to be releasably connected to the plurality of peripherals, wherein the interface omits any active components.

25. The connection interface of claim 24 including a printed circuit board between the first connector portion and the plurality of second connector portions.

26. The connection interface of claim 24, wherein the computer system includes a plurality of cables connected to the plurality of peripherals and wherein the plurality of second connector portions include a plurality of cable connectors.

27. The connection interface of claim 24, wherein the first connector portion and the plurality of second connector portions face in opposite directions.

28. An extender board for use in a computer system having a chassis, a first printed circuit board within the chassis, a plurality of peripherals within the chassis, and a plurality of cables connected to the plurality of peripherals, the extender board comprising:
a second printed circuit board;
a first connector coupled to the second printed circuit board and configured to facilitate connection of the second printed circuit board to the first printed circuit board; and
a plurality of cable connectors coupled to the second printed circuit board and configured to connect the plurality of cables to the second printed 11 circuit board, wherein data signals are transmitted from one of the plurality of peripherals and the first printed circuit board to the other of the plurality of peripherals and the first printed circuit board across the extender board without being received by an active component.

29. The extender board of claim 28, wherein the extender board does not include an active component.

30. The extender board of claim 28, wherein the plurality of cable connectors are configured to face in a direction away from the first printed circuit board when the extender board is connected to the first printed circuit board.

31. The extender board of claim 28, wherein the first connector extends along a first edge of the second printed circuit board and wherein the plurality of cable connectors are proximate a second opposite edge of the second printed circuit board.

32. The extender board of claim 28, wherein the plurality of cable connectors includes at least three cable connectors.

33. The extender board of claim 28, wherein the first printed circuit board has a first length and wherein the second printed circuit board has a second length parallel to the first length and shorter than the first length.

34. The extender board of claim 28, wherein the second printed circuit board has a maximum length of about 5.0 inches.

35. The extender board of claim 34, wherein the second printed circuit board has a maximum height of about 5.0 inches.

36. The extender board of claim 28, wherein the second printed circuit board has a maximum height of about 5.0 inches.

37. A method for removing a printed circuit assembly having at least one component configured to generate data signals that are transmitted to a plurality of internal peripherals, the method comprising:
disconnecting a single connection interface from the printed circuit assembly, the connection interface being connected to each of the plurality of internal peripherals within a chassis; and
removing the printed circuit assembly from the chassis.
